(19) United States
(12) Patent Application Publication
(10) Pub. No.: US 2012/0212632 A1
(43) Pub. Date: Aug. 23, 2012

(54) APPARATUS

(75) Inventors: Sujeet Shyamsundar Mate, Tampere (FI); Radu Ciprian Bilcu, Tampere (FI); Igor Danilo Diego Curcio, Tampere (FI)

(73) Assignee: NOKIA CORPORATION, Espoo (FI)

(21) Appl. No.: 13/394,753

(22) PCT Filed: Sep. 7, 2009
(86) PCT No.: PCT/EP09/61552

§ 371 Date: Apr. 20, 2012

(51) Int. Cl. H04N 5/232; G06F 17/28; H04N 5/225

(52) U.S. Cl. 348/207.11; 348/207.1; 704/2; 348/E05.024; 348/E05.045

(57) ABSTRACT

An apparatus comprising at least one processor and at least one memory including computer program code the at least one memory and the computer program code configured to, with the at least one processor, cause the apparatus at least to perform: generating a content request comprising a first content parameter; receiving a first content message comprising at least one image frame associated with the first content parameter; determining at least one further content parameter dependent on the content message; generating a content selection message comprising the least one further content parameter; and receiving a further content message, wherein the further content message comprises content generated dependent on the at least one further content parameter.

The present application relates to a method and apparatus. In some embodiments the method and apparatus relate to image processing and in particular, but not exclusively limited to, some further embodiments relate to multi-frame image processing.

Imaging capture devices and cameras are generally known and have been implemented on many electrical devices. Furthermore there is a need for ‘on request’ image or video capture and distribution. Although live event reporting is available, such video production methods are costly may suffer from lengthy setup times, and may not be available in jurisdictions where press freedoms are limited. Thus it is often the case that a news organization is unable to get professional news teams and equipment to the scene of a breaking news event before the event is over.

Attempts have been made to make the coverage and broadcast of events more flexible by the use of video and audio reports produced by people who happen to be at the scene in place of professional reporters. Citizen reporting together with Internet forums developed to enable content generators to upload images video or audio recordings, enable content producers to tag their video with a location and/or event location where the video originated. However such reporting does not provide live or near live content gathering.

Live content gathering in the form of video-on-request systems have been discussed. In such systems an information exchange server with a content producer database of known locations of potential content producing devices, enables a requester to request content from a desired location by sending a message to a content provider (also referred to as “a rent-cam”) via the medium of Internet. However the operator of the content producing device, although being at the correct point may still miss the image or video subject requested.

The form of the request for example may be itself problematic and a serious limitation towards understanding the context of the request. For example, if the request contained added contextual information is in form of text, consisting of “East side view of the castle”, the content provider is unlikely to know what feature of the view is the requested feature. For example is the requested feature of the ‘east side view of the castle’ the façade, the armour-plated door, or the stone masonry of the walls. Furthermore explicit information may not be practical considering that most users of content requesting apparatus would not want to write more than a couple of sentences to describe their request. Also the user of the content provider may not always be in a position to completely understand the request due to cultural differences or/and differing language interpretation.

This application therefore proceeds from the consideration that an improved content-on-request system can be built by the requesting user (henceforth referred to as requester or content requester) adding contextual information either when requesting the content from the specified geographical location, or after receiving preliminary content information. The requester thus may make a request for certain content (images, video or text, or other media) to a mobile user containing some contextual information about the content being requested from a certain location.

There is provided according to a first aspect of the invention a method comprising generating a content request comprising a first content parameter; receiving a first content message comprising at least one image frame associated with the first content parameter; determining at least one further content parameter dependent on the content message; generating a content selection message comprising the least one further content parameter; and receiving a further content message, wherein the further content message comprises content generated dependent on the at least one further content parameter.

The first content parameter may comprise an identifier configured to identify a content provider apparatus.

The first content parameter may comprise at least one of: location information configured to identify a location from which to capture content; directional information configured to identify a direction from which to capture content; validity timestamp information configured to identify the time period for which the request is valid for; and contextual information configured to identify the content subject.

The method may further comprise transmitting the content request to at least one content provider apparatus.

The method may further comprise selecting a region of interest from the at least one image frame, and wherein determining at least one further content parameter comprises determining the at least one further parameter for the region of interest.

The first content message may further comprise at least one of: a location part configured to identify the location from which the at least one image frame was captured; a directional part configured to identify the direction from which the at least one image frame was captured; and a settings part configured to identify the capture settings for the at least one image frame.

The settings part may comprise at least one of: focal information configured to identify the focal point for the at least one image frame; exposure information configured to identify the exposure for the at least one image frame; analog gain information configured to identify the analog gain for the at least one image frame; zoom information configured to identify the optical and/or digital zoom for the at least one image frame; and flash information configured to identify the flash mode for the at least one image frame.

The at least one further content parameter may comprise at least one of: location information configured to identify at least one location from which to capture content; directional information configured to identify at least one direction from which to capture content; contextual information configured to identify the content subject; and settings information for configuring a content capture apparatus.

The settings information may comprise at least one of: focal settings; exposure settings; analog gain settings; zoom settings; and flash settings.

The location information and/or directional information may define a path to follow while capturing content.

The method may further comprise transmitting the content selection message to at least one content capture apparatus.

The content request may further comprise a translation value, indicating the language used in the content request.

According to a second aspect of the invention there is provided a method comprising receiving a content request comprising a first content parameter; generating a first content message comprising at least one image frame associated with the first content parameter; receiving a content selection message comprising at least one further content parameter, the at least one further content parameter being determined dependent on the content message; and generating a further content message dependent on the at least one further content parameter.

The first content parameter may comprise at least one of: location information configured to identify a location from which to generate a first content message; directional information configured to identify a direction from which to generate a first content message; time stamp information configured to identify the time period for which the request is valid for; and contextual information configured to identify the first content message subject.

The method may further comprise transmitting the first content message to at least one content requester apparatus.

The first content message may further comprise at least one of: a location part configured to identify the location from which the at least one image frame was generated; a directional part configured to identify the direction from which the at least one image frame was generated; and a settings part configured to identify the image settings for the generated at least one image frame.

The settings part may comprise at least one of: focal information configured to identify the focal point for the at least one image frame; exposure information configured to identify the exposure for the at least one image frame; analog gain information configured to identify the analog gain for the at least one image frame; zoom information configured to identify the optical and/or digital zoom for the at least one image frame; and flash information configured to identify the flash mode for the at least one image frame.

The at least one further content parameter may comprise at least one of: location information configured to identify at least one location from which to generate a further content message; directional information configured to identify at least one direction from which to generate a further content message; contextual information configured to identify the content subject; and settings information for configuring a content capture apparatus.

The settings information may comprise at least one of: focal settings; exposure settings; analog gain settings; zoom settings; and flash settings.

The location information and/or directional information may define a path to follow while capturing content.

The method may further comprise transmitting the further content message to at least one content requester apparatus.

According to a third aspect of the invention there is provided a method comprising receiving a content request comprising a first text part and a translation value configured to indicate the language used in the first text part; identifying at least one content provider dependent on the content request; generating a translated first text part in a language used by the at least one content provider from the first text part; and generating a further content request addressed to the at least one content provider, the further content request comprising the translated first text part.

According to a fourth aspect of the invention there is provided an apparatus comprising at least one processor and at least one memory including computer program code the at least one memory and the computer program code configured to, with the at least one processor, cause the apparatus at least to perform: generating a content request comprising a first content parameter; receiving a first content message comprising at least one image frame associated with the first content parameter; determining at least one further content parameter dependent on the content message; generating a content selection message comprising the least one further content parameter; and receiving a further content message, wherein the further content message comprises content generated dependent on the at least one further content parameter.

The first content parameter may comprise an identifier configured to identify a content provider apparatus.

The first content parameter may comprise at least one of: location information configured to identify a location from which to capture content; directional information configured to identify a direction from which to capture content;

validity timestamp information configured to identify the time period for which the request is valid for; and contextual information configured to identify the content subject.

The at least one memory and the computer program code configured to, with the at least one processor, may cause the apparatus at least to further perform transmitting the content request to at least one content provider apparatus.

The at least one memory and the computer program code configured to, with the at least one processor, may cause the apparatus at least to further perform selecting a region of interest from the at least one image frame, and wherein determining at least one further content parameter may comprise determining the at least one further parameter for the region of interest.

The first content message may further comprise at least one of: a location part configured to identify the location from which the at least one image frame was captured; a directional part configured to identify the direction from which the at least one image frame was captured; and a settings part configured to identify the capture settings for the at least one image frame.

The settings part may comprise at least one of: focal information configured to identify the focal point for the at least one image frame; exposure information configured to identify the exposure for the at least one image frame; analog gain information configured to identify the analog gain for the at least one image frame; zoom information configured to identify the optical and/or digital zoom for the at least one image frame; and flash information configured to identify the flash mode for the at least one image frame.

The at least one further content parameter comprises at least one of: location information configured to identify at least one location from which to capture content; directional information configured to identify at least one direction from which to capture content; contextual information configured to identify the content subject; and settings information for configuring a content capture apparatus.

The settings information may comprise at least one of: focal settings; exposure settings; analog gain settings; zoom settings; and flash settings.

The location information and/or directional information may define a path to follow while capturing content.

The at least one memory and the computer program code configured to, with the at least one processor, may cause the apparatus at least to further perform transmitting the content selection message to at least one content capture apparatus.

The content request may further comprises a translation value, indicating the language used in the content request.

According to a fifth aspect of the invention there is provided an apparatus comprising at least one processor and at least one memory including computer program code the at least one memory and the computer program code configured to, with the at least one processor, cause the apparatus at least to perform: receiving a content request comprising a first content parameter; generating a first content message comprising at least one image frame associated with the first content parameter; receiving a content selection message comprising at least one further content parameter, the at least one further content parameter being determined dependent on the content message; and generating a further content message dependent on the at least one further content parameter.

The first content parameter may comprise at least one of: location information configured to identify a location from which to generate a first content message; directional information configured to identify a direction from which to generate a first content message; time stamp information configured to identify the time period for which the request is valid for; and contextual information configured to identify the first content message subject.

The at least one memory and the computer program code configured to, with the at least one processor, may cause the apparatus at least to further perform transmitting the first content message to at least one content requester apparatus.

The first content message may further comprise at least one of: a location part configured to identify the location from which the at least one image frame was generated; a directional part configured to identify the direction from which the at least one image frame was generated; and a settings part configured to identify the image settings for the generated at least one image frame.

The settings part may comprise at least one of: focal information configured to identify the focal point for the at least one image frame; exposure information configured to identify the exposure for the at least one image frame; analog gain information configured to identify the analog gain for the at least one image frame; zoom information configured to identify the optical and/or digital zoom for the at least one image frame; and flash information configured to identify the flash mode for the at least one image frame.

The at least one further content parameter may comprise at least one of: location information configured to identify at least one location from which to generate a further content message; directional information configured to identify at least one direction from which to generate a further content message; contextual information configured to identify the content subject; and settings information for configuring a content capture apparatus.

The settings information may comprise at least one of: focal settings; exposure settings; analog gain settings; zoom settings; and flash settings.

The location information and/or directional information may define a path to follow while capturing content.

The at least one memory and the computer program code configured to, with the at least one processor, may cause the apparatus at least to further perform transmitting the further content message to at least one content requester apparatus.

According to a sixth aspect of the invention there is provided an apparatus comprising at least one processor and at least one memory including computer program code the at least one memory and the computer program code configured to, with the at least one processor, cause the apparatus at least to perform: receiving a content request comprising a first text part and a translation value configured to indicate the language used in the first text part; identifying at least one content provider dependent on the content request; generating a translated first text part in a language used by the at least one content provider from the first text part; and generating a further content request addressed to the at least one content provider, the further content request comprising the translated first text part.

According to a seventh aspect of the invention there is provided a computer-readable medium encoded with instructions that, when executed by a computer, perform: generating a content request comprising a first content parameter; receiving a first content message comprising at least one image frame associated with the first content parameter; determining at least one further content parameter dependent on the content message; generating a content selection message comprising the least one further content parameter; and receiving a further content message, wherein the further content message comprises content generated dependent on the at least one further content parameter.

According to an eighth aspect of the invention there is provided a computer-readable medium encoded with instructions that, when executed by a computer, perform: receiving a content request comprising a first content parameter; generating a first content message comprising at least one image frame associated with the first content parameter; receiving a content selection message comprising at least one further content parameter, the at least one further content parameter being determined dependent on the content message; and generating a further content message dependent on the at least one further content parameter.

According to a ninth aspect of the invention there is provided a computer-readable medium encoded with instructions that, when executed by a computer, perform: receiving a content request comprising a first text part and a translation value configured to indicate the language used in the first text part; identifying at least one content provider dependent on the content request; generating a translated first text part in a language used by the at least one content provider from the first text part; and generating a further content request addressed to the at least one content provider, the further content request comprising the translated first text part.

According to a tenth aspect of the invention there is provided an apparatus comprising request generating means for generating a content request comprising a first content parameter; receiving means for receiving a first content message comprising at least one image frame associated with the first content parameter; processing means for determining at least one further content parameter dependent on the content message; message generating means for generating a content selection message comprising the least one further content parameter; and further receiving means for receiving a further content message, wherein the further content message comprises content generated dependent on the at least one further content parameter.

According to an eleventh aspect of the invention there is provided an apparatus comprising receiving means for receiving a content request comprising a first content parameter; generating means for generating a first content message comprising at least one image frame associated with the first content parameter; further receiving means for receiving a content selection message comprising at least one further content parameter, the at least one further content parameter being determined dependent on the content message; and further generating means for generating a further content message dependent on the at least one further content parameter.

According to a twelfth aspect of the invention there is provided an apparatus comprising receiving means for receiving a content request comprising a first text part and a translation value configured to indicate the language used in the first text part; identifying means for identifying at least one content provider dependent on the content request; generating means generating a translated first text part in a language used by the at least one content provider from the first text part; and request generating means generating a further content request addressed to the at least one content provider, the further content request comprising the translated first text part.

An electronic device may comprise apparatus as described above.

A chipset may comprise apparatus as described above.

According to a thirteenth aspect of the invention there is provided an apparatus comprising a request generator configured to generate a content request comprising a first content parameter; a receiver configured to receive a first content message comprising at least one image frame associated with the first content parameter; a content message processor configured to determine at least one further content parameter dependent on the content message; a message generator configured to generate a content selection message comprising the least one further content parameter; and wherein the receiver is further configured to receive a further content message, wherein the further content message comprises content generated dependent on the at least one further content parameter.

According to a fourteenth aspect of the invention there is provided an apparatus comprising a receiver configured to receive a content request comprising a first content parameter; a content message generator configured to generate a first content message comprising at least one image frame associated with the first content parameter; wherein the receiver is further configured to receive a content selection message comprising at least one further content parameter, the at least one further content parameter being determined dependent on the content message; and the content message generator further configured to generate a further content message dependent on the at least one further content parameter.

According to a fifteenth aspect of the invention there is provided an apparatus comprising a receiver configured to receive a content request comprising a first text part and a translation value configured to indicate the language used in the first text part; a content provider identifier configured to identify at least one content provider dependent on the content request; a translation generator configured to generate a translated first text part in a language used by the at least one content provider from the first text part; and a request generator configured to generate a further content request addressed to the at least one content provider, the further content request comprising the translated first text part.

For a better understanding of the present application and as to how the same may be carried into effect, reference will now be made by way of example to the accompanying drawings in which:

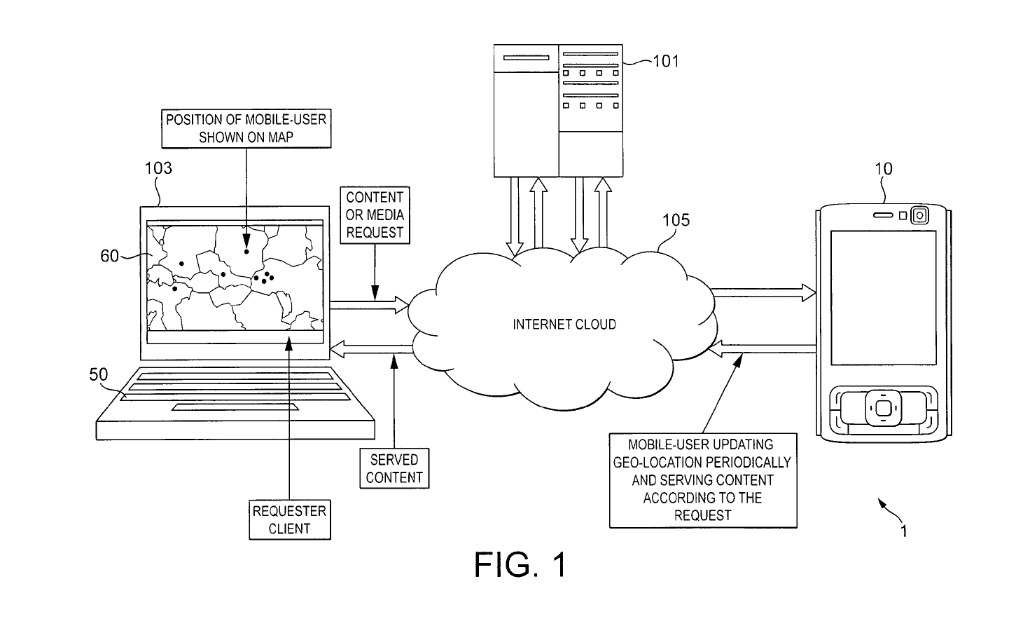

FIG. 1 shows schematically a system within which embodiments may be applied;

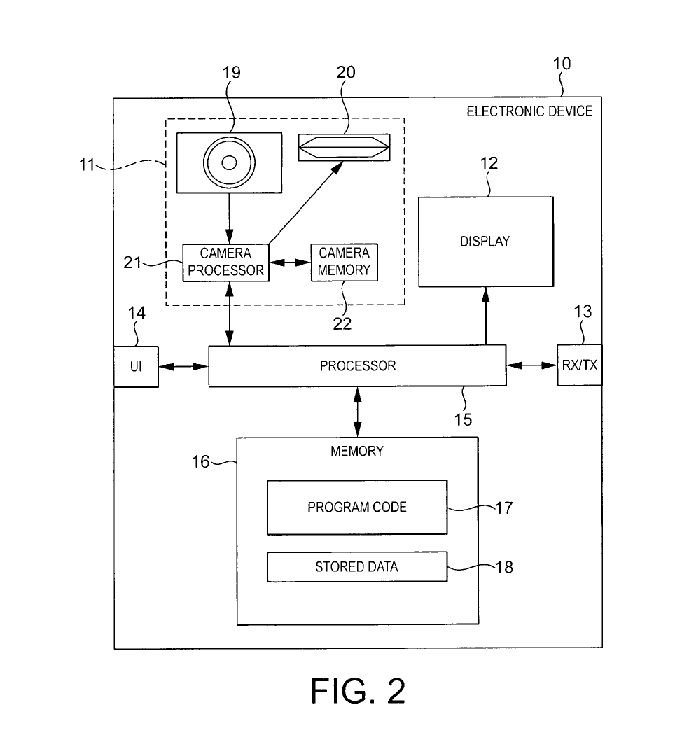

FIG. 2 shows a schematic representation of a content provider apparatus as shown in FIG. 1 suitable for implementing some embodiments of the application;

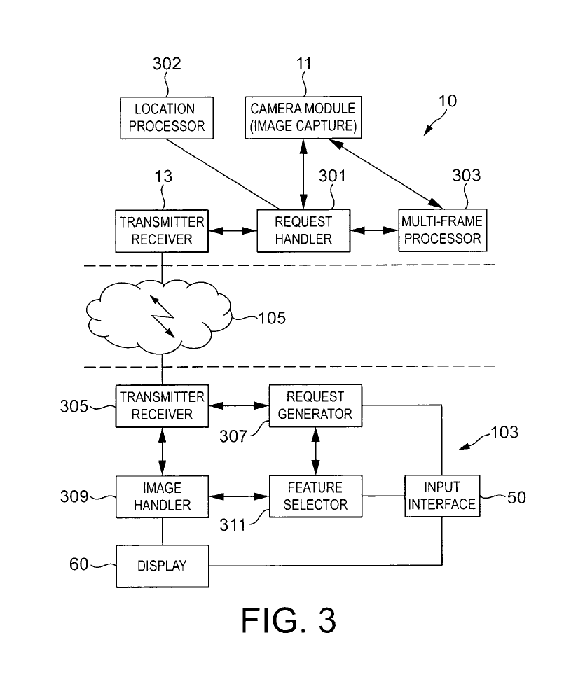

FIG. 3 shows a schematic representation of the content provider apparatus and the content requester apparatus as shown in FIG. 1 according to embodiments of the application;

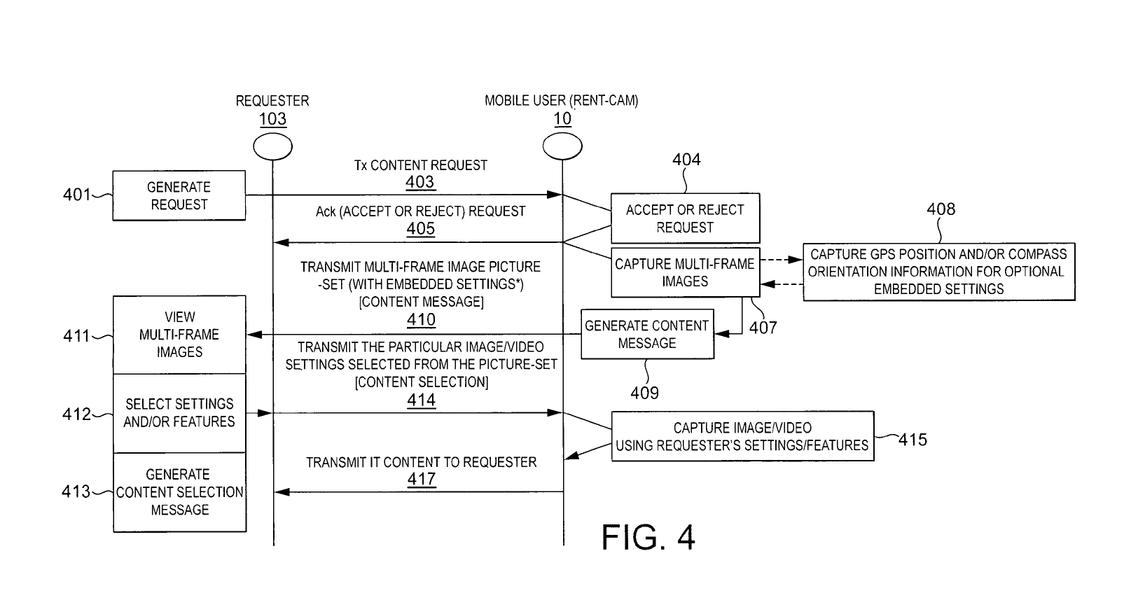

FIG. 4 shows a flow diagram of the processes carried out according to some embodiments of the application; and

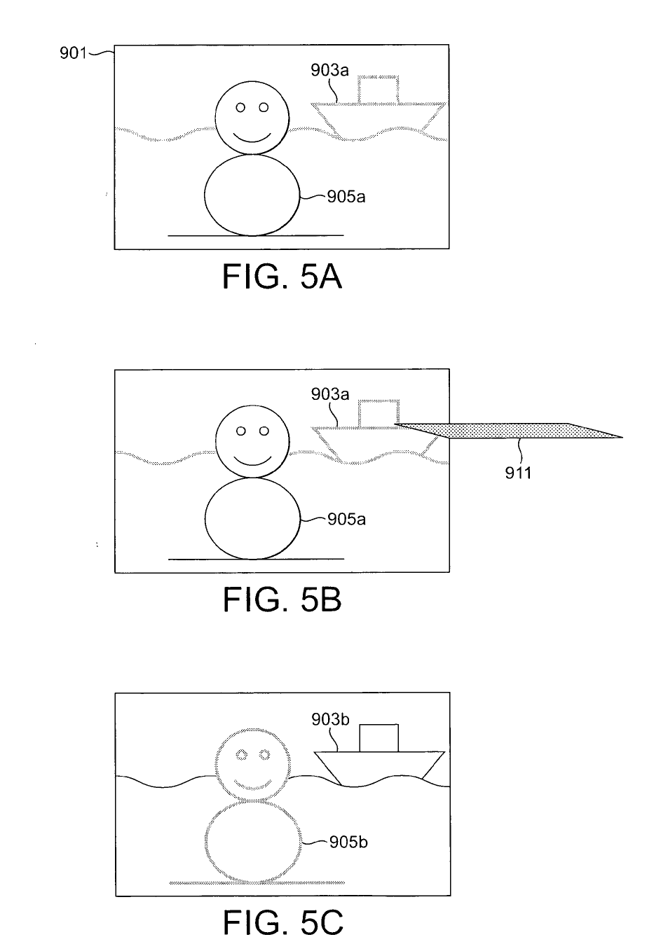

FIG. 5 shows an example of images provided in some embodiments.

The application describes apparatus and methods to enable more efficient operation for ‘content-on-request’ systems from the point of view of both the content provider apparatus and the content requester apparatus. The embodiments described hereafter may be utilised in various applications and situations.

Such a system and apparatus described below enables a smoother operation of the service of matching content requesters and content providers spanning multiple cultures, languages and the subsequent transfer of content more closely matching the content requested. The following therefore describes apparatus and methods for the provision of improved content requesting and content provision. In this regard reference is first made to FIG. 1, which discloses a schematic block diagram of an exemplary content matching system 1. The system 1 comprises a content requester 103, a content provider 10 and an information exchange 101. The content requester 103, content provider 10 and information exchange 101 are shown to communicate with each other via an ‘Internet cloud’ 105. However in some other embodiments any suitable network communications system may be used to communicate between the content requester 103, content provider 10 and information exchange 101. Furthermore although the system is shown with a single content requester 103, and a single content provider 10 it would be understood that a content provision system 1 may comprise any suitable number of content providers 10 and content requesters 103. Furthermore the information exchange 101 in some embodiments may be implemented in more than one physical location and may be distributed over several parts of the communication network.

The information exchange 101 may in some embodiments comprise a content producer database configured to store a content provider profile and in some other embodiments also store content requester profile information. The content requester may in some embodiments maintain an indication of the content requester language preference. The content provider profile may in some embodiments maintain an indication of the content provider current location and status. The content provider may in some embodiments maintain content provider language preference setting in addition to the current location and status. The status indication in some embodiments may be whether the content provider is active and capable of providing content (in other words available for commissions and requests) or inactive and unable to provide content (for example when the user of the content provider 10 is asleep). The current location and status are in some embodiments continually updated based on the location data and user input of the content provider 10. The information exchange may in some embodiments provide translation feature if the content requester and content provider languages are different. The information exchange may in some embodiments provide some or all of the profile information to the content requester 103.

The content requester 103 as shown in FIG. 1 is a portable computer comprising a display 60 and input 50. It would be understood that the content requester 103 may, depending on the embodiment, be implemented in any electronic apparatus suitable for communication with the content provider 10 and the information exchange 101 and may for example be a user equipment or desktop computer. The display 60 may be any suitable size and may be implemented by any suitable display technology. The input 50 shown in FIG. 1 is a keyboard input however the input may be any suitable input of groups of inputs (including for example pointer devices, mice, touch screens, virtual keyboards, or voice or gesture input devices) suitable for providing selection and data input to the content requester 103.

The content requester display 60 may in some embodiments and in response to the profile information from the information exchange 101 display the location and availability of the content providers known to the information exchange. For example FIG. 1 shows that the display indicates the position of each available content provider 10 marked on a map of the world. Furthermore the input 50 may in some embodiments be used by a user to search the provider database for available content providers 10 within a predetermined range of a desired location. Using the profile information displayed on the display 60 and the input 50 and on finding an available content provider 10 at the desired location, the content requester 103 as described in further detail later requests a first content segment to be produced by the content provider at the desired location. The content provider 10 may then record the information or content segment and transmits the content segment to the content requester 103 via in some embodiments the internet cloud 105.

FIG. 2 discloses a schematic block diagram of an exemplary electronic device 10 or apparatus performing the operations of the content provider. The electronic device may in some embodiments be configured to perform multi-frame imaging techniques.

The electronic device 10 is in some embodiments a mobile terminal, mobile phone or user equipment for operation in a wireless communication system. In other embodiments, the electronic device is a digital camera.

The electronic device 10 comprises an integrated camera module 11, which is linked to a processor 15. The processor 15 is further linked to a display 12. The processor 15 is further linked to a transceiver (TX/RX) 13, to a user interface (UI) 14 and to a memory 16. In some embodiments, the camera module 11 and/or the display 12 is separate from the electronic device and the processor receives signals from the camera module 11 via the transceiver 13 or another suitable interface. In some embodiments the electronic device further comprises suitable audio capture and processing modules for the capture of audio. This audio capture may be linked to the image capture apparatus in the camera module to enable audio-video content to be captured. In other embodiments the audio capture and/or processing modules are separate from the electronic device 10 and the processor receives signals from the audio capture and/or processing modules via the transceiver 13 or another suitable interface. In the following examples we describe the content being purely frame image based however it would be understood that any suitable video, audio-video or audio based content may be provided using similar apparatus and methods.

The processor 15 may be configured to execute various program codes 17. The implemented program codes 17, in some embodiments, comprise image capture digital processing or configuration code. The implemented program codes 17 in some embodiments further comprise additional code for further processing of images. The implemented program codes 17 may in some embodiments be stored for example in the memory 16 for retrieval by the processor 15 whenever needed. The memory 15 in some embodiments may further provide a section 18 for storing data, for example data that has been processed in accordance with the application.

The camera module 11 comprises a camera 19 having a lens for focussing an image on to a digital image capture means such as a charged coupled device (CCD). In other embodiments the digital image capture means may be any suitable image capturing device such as complementary metal oxide semiconductor (CMOS) image sensor. The camera module 11 further comprises a flash lamp 20 for illuminating an object before capturing an image of the object. The flash lamp 20 is linked to the camera processor 21. The camera 19 is also linked to a camera processor 21 for processing signals received from the camera. The camera processor 21 is linked to camera memory 22 which may store program codes for the camera processor 21 to execute when capturing an image. The implemented program codes (not shown) may in some embodiments be stored for example in the camera memory 22 for retrieval by the camera processor 21 whenever needed. In some embodiments the camera processor 21 and the camera memory 22 are implemented within the apparatus 10 processor 15 and memory 16 respectively.

The apparatus 10 may in embodiments be capable of implementing multi-frame imaging techniques in at least partially in hardware without the need of software or firmware.

The user interface 14 in some embodiments enables a user to input commands to the electronic device 10, for example via a keypad, user operated buttons or switches or by a touch interface on the display 12. One such input command may be to start an image capture process by for example the pressing of a ‘shutter’ button on the apparatus. Furthermore the user may in some embodiments obtain information from the electronic device 10, for example via the display 12 of the operation of the apparatus 10. For example the user may be informed by the apparatus of a request for an image from the image requester 103 or that an image capture process is in operation by an appropriate indicator on the display. In some other embodiments the user may be informed of operations by a sound or audio sample via a speaker (not shown), for example the same image capture operation may be indicated to the user by a simulated sound of a mechanical lens shutter.

The transceiver 13 enables communication with other electronic devices, for example in some embodiments via a wireless communication network.

It is to be understood again that the structure of the electronic device 10 could be supplemented and varied in many ways.

A user of the electronic device 10 may use the camera module 11 for capturing images to be transmitted to some other electronic device or that is to be stored in the data section 18 of the memory 16. A corresponding application in some embodiments may be activated to this end by the user via the user interface 14. This application, which may in some embodiments be run by the processor 15, causes the processor 15 to execute the code stored in the memory 16.

The resulting image may in some embodiments be provided to the transceiver 13 for transmission to another electronic device. Alternatively, the processed digital image could be stored in the data section 18 of the memory 16, for instance for a later transmission or for a later presentation on the display 10 by the same electronic device 10.

It would be appreciated that the schematic structures relating to the application shown in FIG. 3 and the method steps in FIG. 4 represent only a part of the operation of a complete multimedia content provision implemented in the system devices such as shown in FIGS. 1 and 2.

FIG. 3 shows a schematic configuration view of the content requester apparatus 103 and the content provider 10 from the viewpoint of some embodiments of the application.

In some embodiments of the application the apparatus may comprise some but not all of the parts described in further detail. For example in some embodiments the parts or modules represent not separate processors but parts of a single processor configured to carry out the processes described below, which are located in the same, or different chip sets. For example in some embodiments with respect to the content provider apparatus the processor 15 shown in FIG. 2 is configured to carry out all of the processes and FIG. 3 exemplifies the processing and encoding of requests and images.

The operation of content requesting and providing according to at least one embodiment will be described in further detail with reference to FIG. 4. Where elements similar to those shown in FIGS. 1 and 2 are described, the same reference numbers are used.

With respect to FIG. 3, the content requester 103 is shown comprising a request generator 307 configured to generate context related requests. The request generator 307 may in some embodiments receive inputs from the input interface 50. In these embodiments the input from the input interface 50 may be a simple selection of a particular content provider 10 or may in other embodiments involve a data search of the content provider 10 from at least part of the profile information. In these embodiments the user of the content requester 103 may therefore enter a search term, for example a geographical location, and the request generator 307 may select a content provider 10 closest to the search term. In other embodiments the request generator 307 may output to the display 60 a list of content providers which match or are within defined tolerances of the search term so that the user of the content requester 103 may then select one of the content providers from the list. The request generator 307 may then generate a content request addressed to the selected content provider 10. In some embodiments more than one content provider 10 may be selected and the request generator generates a request addressed to each of the content providers 10. In such embodiments the request generator may be configured to later generate a request recall to cancel the request when one content provider provides the content.

In some embodiments the user may input using the input interface 50 a brief context field into the request. The context information in addition to the location may be text, for example “ship to be photographed” or a combination of text, images, or video such that the requirements of the content requester 103 become clear to the content provider 10 to the extent possible but at the same time keeping the resource requirements to a minimum in terms of network usage and mobile phone usage.

In some embodiments of the application, the request generator 307 may generate requests comprising a validity time stamp which determines a period of time for which a request is valid. For example for near real time news gathering applications the request may be valid for only a short amount of time, for example 1 to 10 minutes, however in other applications where time is less critical, the validity time stamp may be measured in hours or there may be no limit to the validity time stamp.

In some embodiments the request generator 307 may be part of a software routine which displays content providers on the display 60 of the content requester 103 and wherein the input interface 50 may select one of the displayed content providers from the display 60. The request generator 307 may then in these embodiments generate a content request for the selected content provider 10.

In some embodiments the request generator 307 may generate a ‘general request’ may be generated and addressed to any content provider 10 within a specific geographical region indicated by the user operating the input interface 50. In other embodiments the request generator 307 may generate a ‘global’ or non regional request. The non regional request for example would be suitable for a ‘library image’ of an item such as the content requester 103 requesting an image of a horse. In some embodiments while generating a “global” or non regional request, the content requester could be marked for translation when passing via 101 information exchange.

The request generator 307 may then output the generated request to the transceiver 305.

The generation of the request at the requester 103 is shown in FIG. 4 by step 401.

The content requester transmitter/receiver or transceiver 305 may then transmit the content request to the content provider 10 via the communications network 105. In some embodiments when the request arrives at 101 while being transmitted to the content provider 10, the request may be translated based on the user language setting on content producing device. As shown in FIG. 1, the communications network 105 may comprise several different types of networks including a suitable internet protocol based network, a wireless communications networks such as cellular communications networks, land communications network.

The transceiver 305 may transmit the requests in some embodiments using a hypertext transfer protocol (HTTP). In these embodiments the requests could have advantages such as being firewall friendly, connection oriented and being easy to integrate with web-based applications and services. However it would be understood that any suitable communication protocol, such as session initiation protocol (SIP) or Short Messaging Service (SMS) may be used in other embodiments.

The content provider 10 may in some embodiments comprise a transceiver 13 configured to receive the request and passes the received request to the request handler 301.

The content provider 10 may comprise a request handler 301 configured to in some embodiment determine whether or not the content provider can accept or reject the request. In some embodiments, the request handler 301 may automatically handle the acceptance or rejection of requests based on the status of the content provider 10. For example if the content provider has been set into a meeting, sleep or inactive mode of operation, the request handler 301 may automatically reject the request. In other embodiments the user of the content provider 10 may be notified of all requests received and decide whether or not a request is to be accepted or not.

In some embodiments the request handler 301 may also be configured to accept or reject requests based on the capabilities of the content provider. For example where the request is for video content and the camera module is not equipped to supply video only single image content data because of a lack of processing power the request handler may reject the request.

The request handler 301 may furthermore in some embodiments generate an acknowledgment to the request message which may be either an acceptance or rejection acknowledgment.

The operation of determining whether or not the content provider can accept the request and the generation of an acknowledgement is shown in FIG. 4 by step 404.

The request handler 301 may then in some embodiments pass the acknowledgment to the content provider transmitter/receiver 13 which then transmits the acknowledgement back via the communication network 105 to the content requester 103.

The content provider transceiver 13 may transmit the acknowledgement in some embodiments using the hypertext transfer protocol (HTTP). However other suitable communication protocols may also be used such as session initiation protocol (SIP) or SMS.

The transmission of the acknowledgement is shown in FIG. 4 by step 405.

In some embodiments the acknowledgement to the request at the content requester 103 may be processed. For example in some embodiments on receiving a positive acknowledgement from one content provider in response to a group or global request the request generator 307 may generate a further message to withdraw the requests to prevent multiple versions of the same content being generated.

The request handler 301 may in some embodiments store multiple requests from the same or different content requesters 103.

In some embodiments of the invention, the content provider 10 comprises a location processor 302. The location processor in these embodiments may provide position and/or directional information to the request handler 301. For example the location processor 302 of the content provider 10 may use GPS data to locate the device and further may contain a digital compass to capture the orientation of the content provider 10. In other embodiments the location of the content provider may be determined by any suitable system, for example cellular communication triangulation.

In some embodiments the content provider 10 may operate software which using the location processor 302 location information may update the geographical location of the content provider to the information exchange 101 and/or content requester 103.

In some embodiments the position and/or directional information from the location processor 302 may be used by the request handler 103 to indicate to the user of the content provider when the content provider is at a suitable position/orientation to capture the content according to the requests held in the request handler 301. In other embodiments the user of the content provider may determine when the content provider is at a suitable position/orientation to capture the content according to the requests.

The content provider in some embodiments comprises a camera module 11 configured to capture images and in some embodiments video images. In some embodiments of the invention the camera module 11 may automatically perform an image capture process when the position/orientation of the content provider 10 location processor matches the position/orientation within the request. In other embodiments the user of the content provider manually starts the image capture process. This manual starting of the image capture process in some embodiments is in response to receiving the indicator described above.

The camera module in some embodiments performs an image capture, where multiple images are captured with each image having a different camera setting. For example in some embodiments the image capture process generates multiple images where the camera focus settings are set at different focus settings. In other embodiments the camera settings which differ between each of the images could be zoom settings, exposure settings, and flash modes.

The content provider further comprises a multi-frame processor 303 which in some embodiments receives the multiple images from the camera module and processes the multiple images to produce a single frame image containing an encoded version of all of the image data from the multiple images. The multi-frame processor 303 may use any suitable multi-frame processing operation to generate the ‘single frame image’ from the multiple images. The multi-frame processor may then pass the single frame image to the request handler 301.

The operation of capturing/processing the multi-frame image is shown in FIG. 4 in step 407.

The location processor 302 may in some embodiments also pass position and/or orientation information to the request handler 301 to locate/orientate the content provider 10 at the point of image capture.

The operation of providing position and/or orientation information for some embodiments where optional embedded settings are included is shown in step 408 of FIG. 4.

The request handler 301 in some embodiments may generate a content message using multi-frame image data in response to the request. In some embodiments the content message may also comprise the location/orientation data from the location processor 302. The content message is passed to the content provider transceiver 13.

The generation of the content message is shown in FIG. 4 by step 409.

The transmitter/receiver 13 transmits the content message over the network 105 to the content requester 103. The content message may use the HTTP or

SIP protocols. However, in some embodiments a more delay friendly application protocol such at real time transport protocol (RTP), over a user datagram protocol (UDP) or internet protocol (IP) transport network may be used. In other embodiments, other non IP protocols can be used, such as SMS.

The transceiver 305 of the content requester 103 receives the content message with the multi-frame image.

The content requester 103 further comprises an image handler 309. The image handler may be configured to receive the image data from the content message and may in some embodiments implement a multi-frame image decoder. The image handler 309 may in some embodiments output to the display one, typically a reference image from the multi-frame image, of the multi-frame images.

The display 60 may in some embodiments display the single frame image for the user of the content requester 103.

FIG. 5a shows, for example, a displayed image from a multi-frame image set. FIG. 5a specifically shows the image 901 with a person 905a in the foreground and a ship 903a in the background. In this displayed image the person 905a is in focus and the ship 905a is out of focus.

The viewing of multi-frame image operation is shown in FIG. 4 by step 411.

The content requester 103 may further comprise a feature selector 311. The user via the input interface 50 may indicate to the feature selector 311 which part of an image is wanted.

For example with reference to FIG. 5b, the content requester 103 may wish to focus on the ship 903a in the background and not as currently in focus the person 905a in the foreground. Although in this example the request generator 307 generated a request specifying a particular direction and location for the content provider 10, the delay between generation of the request and the content provider 10 positioned and orientated meant that the image capture had framed the person 905a in the foreground rather than the desired ship 903a in the background. The content requester 903 on reviewing the reference image from the multi-frame image picture may use a pointer 911 controlled by the input interface 50 to select the ship part of the reference image.

The feature selector 311 in some embodiments identifies that the ship has been selected.

In some embodiments the feature selector 311 may communicate with the image handler 309 to determine if there are better camera settings for the selected image part. For example as shown in FIG. 5c, the image handler may output to the display 60 the image with an in focus ship 903b and an out of focus person 905b.

In some embodiments of the invention the feature selector 311 may pass these better camera settings for the selected image part to request generator 307. In other embodiments the feature selector 311 may also determine and pass to the request generator the content type required, for example whether or not a single image or video images are required and/or if audio is to be captured as well as or instead of image capture.

In other embodiments the feature selector 311 furthermore determines specific camera or audio capture settings based on the selected feature element and the received content message data. In other embodiments the feature selector 311 may furthermore determine a direction/orientation indication to the content provider 10 to obtain better content. In the example shown in FIG. 5c the feature selection may indicate a slightly different orientation to reframe the image or a different location to move the content provider past the person in the foreground.

In other embodiments the feature selector 311 may be based on the received GPS and orientation information to suggest a “path” for the content provider 10 to follow when capturing the multimedia content. In such a way, the content requester 105 may provide direction to the content provider 10.

The selection of settings and/or features is shown in FIG. 4 by step 412.

The request generator 307 may then in some embodiments generate a content selection message with the settings/features from the feature selector 311. The generation of the content selection message is shown in FIG. 4 by step 413.

The transceiver 305 then in some embodiments transmits this content selection message to the content provider 10 over the network 105. The transceiver 305 may transmit the content selection message in some embodiments using a hypertext transfer protocol (HTTP). In other embodiments any suitable protocols, such as session initiation protocol (SIP) or SMS may be used.

The transmission of the particular image/video settings selected is shown in FIG. 4 by step 414.

The content provider 10 receives the content selection message containing the selected settings and features at the transceiver 13 and passes the message to the request handler 301.

The request handler 301 in some embodiments may initialise the camera module 11 according to the settings, for example set the focus at the ship in the background rather than the person in the foreground, and/or zoom the image to better frame the ship. Furthermore, in collaboration with the location processor 302, the received content selection message may display to the user of the content provider 10 the “path” to follow either to capture the content more efficiently or to produce the series of images the content requester desires.

For example where the content provider 10 has moved since taking the multi-frame image, the content selection information and the location processor 302 output may enable the content provider 10 to display a series of instructions to enable the content provider to arrive at the location and orientation to better capture the media requested. For example the content provider 10 may display the instructions, “Follow path X on the map and when arriving at point Y on the map, turn to direction Z and capture a picture with camera settings A and send it to the content requester”. In these embodiments, the content provider 10 need not necessarily stay at the same location while awaiting the content selection message. In some embodiments, the camera settings may be hidden to the user of the content provider 10, for example the request handler 301 may configure the camera module 11 with specific settings for example exposure time, focal information, zoom, and flash mode.

In other embodiments the request handler 301 may furthermore configure the camera module to make the image capture process substantially automatic by triggering the camera module to start content capture dependent on the information from the location processor 302 and the information in the content selection message. In such embodiments the content provider may display to the user when the content provider is at the desired location and/or orientation. The display may be for example implemented as a position and orientation on a map. Thus, in these embodiments a user may be told roughly which direction and where to stand and the camera module 11 takes the images automatically when the request handler 391 matches the location processor 302 information from the content selection message direction and location information.

The camera module 11 may then in some embodiments capture the content requested according to the settings of the camera module 11 and pass the content to the request handler 301.

The capturing of the image/video using the requested settings/features is shown in FIG. 4 by step 415.

The content in the form of the captured images/video may then be passed to the transceiver which in some embodiments transmits the desired images to the content requester 103.

The transmission of the content to the requester is shown in FIG. 4 by step 417.

In other embodiments of the invention, the request generator of the content requester 103 may allow a request to contain a context information in addition to the location of the image you wish to be captured, the context may be simply text, for example “ship to be photographed” or a combination of text, images, video such that the requirements of the requester become clear to the content provider to the extent possible but at the same time keeping the resource requirements to a minimum in terms of network usage, mobile phone usage. This, for example, may assist in the case shown in FIG. 5 whereby the content requester 103 may send to the content provide an image of the ship and the expected position and orientation to take the photo from which would enable the user to centre the frame and focus the frame on the ship.

In some embodiments, the requests may contain incentives for the content provider 10 to provide the content. These incentives may be implemented by any known method or means.

This apparatus and methods described above enable a better and more efficient content generation and distribution system to be implemented and would significantly improve the direction of citizen journalism, but also create new spaces for entertainment and social application that make use of media content.

Furthermore the content requester 103 using these examples may have the opportunity to choose closer matches from the wide picture set made available to the requester from the content provider 10 using the first set of content information sent from the content provider. This increases the chances of a closer match to the requirements by setting up the camera according to the chosen image from the initial picture frame set.

The direct use of images in conveying information about the current view in the location of interest thus assist in overcoming any complexities from having different languages, cultures or interpretations from the original request.

Furthermore the requester is not required to make unduly, precise and complicated requests that would make the task more complicated to the content provider. Thus the content provider may be simply provided with a small amount of information such as location and orientation and the content requester 103 determines how best to match their requirements with the images available.

In these examples the impersonal means for automatically adjusting the camera settings in some embodiments thus does not require the use of further information such as an instant message or voice communication to explain the request. This may be important where not all of the mobile content providers can request content are known to them. There is a much greater privacy barrier between the content requester and content provider which may be advantageous in such jurisdictions and countries where press freedoms are curtailed.

It shall be appreciated that the term user equipment is intended to cover any suitable type of wireless user equipment, such as mobile telephones, portable data processing devices or portable web browsers. Furthermore user equipment, universal serial bus (USB) sticks, and modem data cards may comprise apparatus such as the apparatus described in embodiments above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

As used in this application, the term circuitry may refer to all of the following: (a) hardware-only circuit implementations (such as implementations in only analogue and/or digital circuitry) and (b) to combinations of circuits and software (and/or firmware), such as and where applicable: (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of circuitry applies to all uses of this term in this application, including in any claims. As a further example, as used in this application, the term circuitry would also cover an implementation of merely a processor (or multiple processors) or portion of a processor and its (or their) accompanying software and/or firmware. The term circuitry would also cover, for example and if applicable to the particular claim element, a baseband integrated circuit or applications processor integrated circuit for a mobile phone or a similar integrated circuit in server, a cellular network device, or other network device.

The term processor and memory may comprise but are not limited to in this application: (1) one or more microprocessors, (2) one or more processor(s) with accompanying digital signal processor(s), (3) one or more processor(s) without accompanying digital signal processor(s), (3) one or more special-purpose computer chips, (4) one or more field-programmable gate arrays (FPGAS), (5) one or more controllers, (6) one or more application-specific integrated circuits (ASICS), or detector(s), processor(s) (including dual-core and multiple-core processors), digital signal processor(s), controller(s), receiver, transmitter, encoder, decoder, memory (and memories), software, firmware, RAM, ROM, display, user interface, display circuitry, user interface circuitry, user interface software, display software, circuit(s), antenna, antenna circuitry, and circuitry.

1-55. (canceled)

56. A method comprising:
generating a content request comprising a first content parameter;
receiving a first content message comprising at least one image frame associated with the first content parameter;
determining at least one further content parameter dependent on the content message;
generating a content selection message comprising the least one further content parameter; and
receiving a further content message, wherein the further content message comprises content generated dependent on the at least one further content parameter.

57. A method comprising:
receiving a content request comprising a first content parameter;
generating a first content message comprising at least one image frame associated with the first content parameter;
receiving a content selection message comprising at least one further content parameter, the at least one further content parameter being determined dependent on the content message; and
generating a further content message dependent on the at least one further content parameter.

58. An apparatus comprising at least one processor and at least one memory including computer program code the at least one memory and the computer program code configured to, with the at least one processor, cause the apparatus at least to perform:
generate a content request comprising a first content parameter;
receive a first content message comprising at least one image frame associated with the first content parameter;
determine at least one further content parameter dependent on the content message;
generate a content selection message comprising the least one further content parameter; and
receive a further content message, wherein the further content message comprises content generated dependent on the at least one further content parameter.

59. The apparatus of claim 58, wherein the first content parameter comprises at least one of:
an identifier configured to identify a content provider apparatus.
a translation value, indicating the language used in the content request;
location information configured to identify a location from which to capture content;
directional information configured to identify a direction from which to capture content;
validity timestamp information configured to identify the time period for which the request is valid for; and
contextual information configured to identify the content subject.

60. The apparatus of 58, wherein the first content message further comprises at least one of:
a location part configured to identify the location from which the at least one image frame was captured;
a directional part configured to identify the direction from which the at least one image frame was captured; and
a settings part configured to identify the capture settings for the at least one image frame.

61. The apparatus of claim 60, wherein the settings part comprises at least one of:
focal information configured to identify the focal point for the at least one image frame;
exposure information configured to identify the exposure for the at least one image frame;
analog gain information configured to identify the analog gain for the at least one image frame;
zoom information configured to identify the optical and/or digital zoom for the at least one image frame; and
flash information configured to identify the flash mode for the at least one image frame.

62. The apparatus of claim 58 wherein the at least one further content parameter comprises at least one of:
location information configured to identify at least one location from which to capture content;
directional information configured to identify at least one direction from which to capture content;
contextual information configured to identify the content subject; and
settings information for configuring a content capture apparatus.

63. The apparatus of claim 62, wherein the settings information comprises at least one of:
focal settings;
exposure settings;
analog gain settings;
zoom settings; and
flash settings.

64. The apparatus of claim 62, wherein the location information and/or directional information may define a path to follow while capturing content.

65. The apparatus of claim 58 the at least one memory and the computer program code configured to, with the at least one processor, cause the apparatus at least to further perform at least one of:
transmit the content request to at least one content provider apparatus;
select a region of interest from the at least one image frame, and wherein determining at least one further content parameter comprises determining the at least one further parameter for the region of interest; and
transmit the content selection message to at least one content capture apparatus.

66. An apparatus comprising at least one processor and at least one memory including computer program code the at least one memory and the computer program code configured to, with the at least one processor, cause the apparatus at least to perform:
receive a content request comprising a first content parameter;
generate a first content message comprising at least one image frame associated with the first content parameter;
receive a content selection message comprising at least one further content parameter, the at least one further content parameter being determined dependent on the content message; and
generate a further content message dependent on the at least one further content parameter.

67. The apparatus of claim 66, wherein the first content parameter comprises at least one of:
location information configured to identify a location from which to generate a first content message;
directional information configured to identify a direction from which to generate a first content message;
time stamp information configured to identify the time period for which the request is valid for; and
contextual information configured to identify the first content message subject.

68. The apparatus of claim 66, wherein the first content message further comprises at least one of:
a location part configured to identify the location from which the at least one image frame was generated;
a directional part configured to identify the direction from which the at least one image frame was generated; and
a settings part configured to identify the image settings for the generated at least one image frame.

69. The apparatus of claim 68, wherein the settings part comprises at least one of:
focal information configured to identify the focal point for the at least one image frame;
exposure information configured to identify the exposure for the at least one image frame;
analog gain information configured to identify the analog gain for the at least one image frame;
zoom information configured to identify the optical and/or digital zoom for the at least one image frame; and
flash information configured to identify the flash mode for the at least one image frame.

70. The apparatus of claim 66 wherein the at least one further content parameter comprises at least one of:
location information configured to identify at least one location from which to generate a further content message;
directional information configured to identify at least one direction from which to generate a further content message;
contextual information configured to identify the content subject; and
settings information for configuring a content capture apparatus.

71. The apparatus of claim 70, wherein the settings information comprises at least one of:
focal settings;
exposure settings;
analog gain settings;
zoom settings; and
flash settings.

72. The apparatus of claim 70, wherein the location information and/or directional information is configured to define a path to follow while capturing content.

73. The apparatus of claim 66, the at least one memory and the computer program code configured to, with the at least one processor, cause the apparatus at least to further perform at least one of:
transmit the first content message to at least one content requester apparatus; and
transmit the further content message to at least one content requester apparatus.

74. An apparatus comprising at least one processor and at least one memory including computer program code the at least one memory and the computer program code configured to, with the at least one processor, cause the apparatus at least to perform:
receive a content request comprising a first text part and a translation value configured to indicate the language used in the first text part;
identify at least one content provider dependent on the content request;
generate a translated first text part in a language used by the at least one content provider from the first text part; and
generate a further content request addressed to the at least one content provider, the further content request comprising the translated first text part.

75. A computer-readable medium encoded with instructions that, when executed by a computer, perform:
generating a content request comprising a first content parameter;
receiving a first content message comprising at least one image frame associated with the first content parameter;
determining at least one further content parameter dependent on the content message;
generating a content selection message comprising the least one further content parameter; and
receiving a further content message, wherein the further content message comprises content generated dependent on the at least one further content parameter.

76. A computer-readable medium encoded with instructions that, when executed by a computer, perform:
receiving a content request comprising a first content parameter;
generating a first content message comprising at least one image frame associated with the first content parameter;
receiving a content selection message comprising at least one further content parameter, the at least one further content parameter being determined dependent on the content message; and
generating a further content message dependent on the at least one further content parameter.

77. A computer-readable medium encoded with instructions that, when executed by a computer, perform:
receiving a content request comprising a first text part and a translation value configured to indicate the language used in the first text part;
identifying at least one content provider dependent on the content request;
generating a translated first text part in a language used by the at least one content provider from the first text part; and
generating a further content request addressed to the at least one content provider, the further content request comprising the translated first text part.
